(19) United States
(12) Patent Application Publication
(10) Pub. No.: US 2021/0178291 A1
(43) Pub. Date: Jun. 17, 2021

(54) Fluid Treatment System and Method of Use Utilizing Compressible Oil Coalescing Media

(71) Applicant: Baleen Process Solutions, Scott, LA (US)

(72) Inventors: Jarid Hugonin, Lafayette, LA (US); Giovanni Occhipiniti, Katy, TX (US); Mike Johnson, Mandeville, LA (US)

(73) Assignee: Baleen Process Solutions, Scott, LA (US)

(21) Appl. No.: 17/181,433

(22) Filed: Feb. 22, 2021

Related U.S. Application Data
(63) Continuation-in-part of application No. 15/600,235, filed on May 19, 2017, now abandoned.
Application No. 15/600,235 is a continuation-in-part of application No. 15/600,277, filed on May 19, 2017.
Application No. 15/600,277 is a continuation-in-part of application No. 16/592,157, filed on Oct. 3, 2019, now Pat. No. 10,953,352.

(51) Int. Cl. B01D 17/04; C02F 1/40

(52) U.S. Cl. CPC B01D 17/045; C02F 2101/32; C02F 1/40

(57) ABSTRACT

A variable oil field fluid treatment system and method of use which utilizes a pump, a compressible media unit for coalescing and removal of oil, vertical or horizontal polishing-unit, and/or combinations therein.

### CROSS-REFERENCE TO RELATED APPLICATIONS

This application is a Continuation-in-Part of and claims priority to U.S. patent application Ser. Nos. 15/600,235, filed on May 19, 2017; 15/600,277, filed on May 19, 2017; and 16/592,157, filed on Oct. 3, 2019, which are incorporated by reference herein in their entirety.

### STATEMENT REGARDING FEDERALLY SPONSORED RESEARCH

Not applicable.

### BACKGROUND

The present invention generally relates to the treatment of well fluids and oilfield wastewater. Relevant background information is discussed below.

The U.S. Environmental Protection Agency (EPA) generally defines an injection well as a bored, drilled, or driven shaft; a dug hole that is deeper than it is wide; an improved sinkhole; or a subsurface fluid distribution system. Some deep wells that are designed to inject hazardous wastes or carbon dioxide deep below the Earth's surface have multiple layers of protective casing and cement, whereas shallow wells injecting non-hazardous fluids into or above drinking water sources are more simply constructed.

In some wastewater disposals, treated wastewater is injected into the ground between impermeable layers of rocks to avoid polluting fresh water supplies or adversely affecting the quality of receiving waters. Injection wells are usually constructed of solid-walled pipe to a deep depth in order to prevent injectate from mixing with the surrounding environment.

Injection wells can be one method for disposal of treated wastewater. Unlike outfalls (discharging on the ground or local stream) or other direct disposal techniques, injection wells utilize the Earth as a filter to further clean the treated wastewater before it reaches the receiving water. This method of wastewater disposal also serves to spread the injectate over a wide area, further decreasing environmental impacts.

There are, in general, disposals for well injections on platforms at sea and on land when water does not meet customer specifications. Some of these waters are disposed to a boat which transports the materials to land for treatment and disposal. Some companies dispose to tanks on platforms then transport, treat, and dispose of the water on land. In other variations, pumps are used to pump well injections into pipelines for transport to salt caverns on land.

Salt caverns are cavities, or chambers, formed in underground salt deposits. Although cavities may naturally form in salt deposits, some caverns are intentionally created by humans for specific purposes, such as for storage of petroleum products or disposal of wastes.

Some removal solutions involve treatment with absorption technologies for discharge overboard from the platform. Some utilize hydrocyclones or both hydrocyclones and absorption technologies in treatment procedures. Some systems treat with coalescing technologies for discharge overboard. Some systems treat with diatomaceous earth technologies. Some systems utilize centrifuge and/or absorption or coalescing technologies. Some removal solutions use conventional solids filtration. Some removal solutions utilize dissolved gas flotation or induced gas flotation technologies.

Within some water-treatment equipment, the process of coalescence takes place; that is, small oil droplets collide and form bigger droplets. Coalescing can also occur in the pipe downstream of pumps and control valves, if enough time is given. However, in such instances, the process of dispersion will govern the maximum size of stable oil droplets that can exist. For normal pipe diameters and flow velocities, particles of 500 to 5000 μm are possible.

A centrifugal water-oil separator, centrifugal oil-water separator or centrifugal liquid-liquid separator is a device designed to separate oil and water by centrifugation. It generally contains a cylindrical container that rotates inside a larger stationary container. The denser liquid, usually water, accumulates at the periphery of the rotating container and is collected from the side of the device, whereas the less dense liquid, usually oil, accumulates at the rotation axis and is collected from the center.

Conventional technologies involved with water treatment and removal often contain oil and grease which utilize expensive chemicals and/or consumable media that requires disposal on land. These consumable media technologies become cost prohibitive as they consume the oil to be removed and still require further disposal. Traditional oil-absorbing media needs to be disposed of once it is utilized, as it becomes a waste product.

A Floating Production, Storage and Offloading (“FPSO”) unit is a floating vessel used by the offshore oil and gas industry for the production and processing of hydrocarbons and for the storage of oil. Produced water that does not meet discharge or injection criteria is diverted into oil storage tanks on FPSO is typically called “slop water”. A FPSO vessel is designed to receive hydrocarbons produced by itself, or from nearby platforms, or from subsea template, process them, and store oil until it can be offloaded onto a tanker or, less frequently, transported through a pipeline. FPSOs are preferred in frontier offshore regions as they are easy to install and do not require a local pipeline infrastructure to export oil. FPSOs can be a converted oil tanker or can be a vessel built specially for the application.

Slop waters are generated from off-specification produced water not suitable for overboard discharge and oily water skimmings from flotation technologies and hydrocyclone rejects. Skimmings, or rejects, are a percentage of the fluid that is not sent out of the discharge of the equipment but is recycled back into the front of the total process. The rejects are mostly water, so they will be recycled back into the total system further upstream.

Slop water can be stored in the compartments within the hull of the ship for days, weeks, months or even years. During this timeframe, chemicals are added to control corrosion, bacteria and H₂S content of the slop water; this causes emulsions to be formed due to the fine solids generated in this treatment. Due to these emulsions, hydrocarbons will not typically be separated from the slop water by gravity separation.

Increased volumes of slop water in tanks reduces the oil storage capacity of these facilities significantly, affecting the economics of an operation. Since the same storage tanks that are designed to hold bulk oil will also hold slop water, the more slop water that is in the tanks, the less amount of oil can be stored. Once the storage tanks are full, whether it is with slop water or oil, the oil will need to be off-loaded.

Deck drainage water, in oil and/or gas drilling and production, comes from collected rainwater and miscellaneous fluids such as oils and greases on a deck of a platform. Typically, several drains are spread throughout one or more decks of the offshore platform, especially on portions of the decks which are open and therefore exposed to the weather. Since the rainwater washes any spilled oil or grease off the deck and into the drains, the rainwater cannot be passed directly into the body of water beneath the platform. Instead, the collected rainwater must be treated to separate the oil from the water until the percentage of oil in the water reaches an acceptable level.

Presently, laws, such as the Clean Water Act, prohibit discharging “pollutants” through a “point source” into a “water of the United States” unless they have an NPDES permit. The permit will contain limits on what an entity can discharge, monitoring and reporting requirements, and other provisions to ensure that the discharge does not hurt water quality or people's health. In essence, the permit translates general requirements of the Clean Water Act into specific provisions tailored to the operations of each person discharging pollutants. Typically (as the governing country's ordinances permit), as little as twenty-nine parts per million “ppm” of oil in water is permitted in the water to be returned to the body of water beneath the platform (in some areas of the world it is 15 ppm).

After primary and secondary recovery, chemical enhanced oil recovery technology can extract almost 20% of additional oil from a reservoir. Polymer flooding is an established chemical enhanced oil recovery process, where an aqueous polymeric solution with a viscosity closely matched to the oil is injected to enhance the mobility of fluid in the reservoir. The fluid injection profile is improved through the addition of polymers, making it more consistent and stable, enhancing the displacement efficiency.

During the primary recovery stage, reservoir drive comes from several natural mechanisms. These include natural water displacing oil downward into the well, expansion of the natural gas at the top of the reservoir, expansion of gas initially dissolved in the crude oil, and gravity drainage resulting from the movement of oil within the reservoir from the upper to the lower parts where the wells are located.

When underground pressure in the oil reservoir is sufficient to force the oil to the surface, all that is necessary is to place a complex arrangement of valves on the well head to connect the well to a pipeline network for storage and processing. Sometimes pumps, such as beam pumps and electrical submersible pumps (ESPs), are used to bring the oil to the surface; these are known as artificial lifting mechanisms.

Over the lifetime of the well, the pressure falls, and at some point, there is insufficient underground pressure to force the oil to the surface. After natural reservoir drive diminishes, secondary recovery methods are applied. Secondary recovery methods can rely on the supply of external energy into the reservoir in the form of injecting fluids to increase reservoir pressure, hence replacing or increasing the natural reservoir drive with an artificial drive. Secondary recovery techniques increase the reservoir's pressure by water injection, natural gas reinjection and gas lift, which injects air, carbon dioxide or some other gas into the bottom of an active well, reducing the overall density of fluid in the wellbore.

The performance of the polymeric solutions used largely relies on their rheological properties; therefore, detailed rheological characterization under relevant conditions supports performance optimization. In addition to the polymers, surfactants can also be added to add additional extraction capabilities. Polymer flooding will increase the viscosity of the water and surfactants will create a tighter oil water emulsion, while the water returning to the surface will be difficult for standard water treatment equipment to maintain efficiencies in recapture.

Oil and gas operators may use acid treatment (acidizing) to improve well productivity. The assortment of drilling fluids pumped down the well during drilling and completion can often cause damage to the surrounding formation by entering the reservoir rock and blocking the pore throats. Similarly, the act of perforating can have a similar effect by jetting debris into the perforation channels. Both these situations reduce the permeability in the near well bore area and so reduce the flow of fluids into the well bore.

One solution is to pump diluted acid mixtures from surface into the well to dissolve the offending material. Once dissolved, permeability should be restored and the reservoir fluids will flow into the well bore, cleaning up what is left of the damaging material. After initial completion, it is common to use minimal amounts of formic acid to clean up any mud and skin damage. In this situation, the process is loosely referred to as “well stimulation.”

In some instances, pumping from the surface is insufficient, as it does not target any particular location downhole and reduces the chances of the chemical retaining its effectiveness if and when it gets to its intended location. In these cases, it is necessary to aim the chemical directly at its target through the use of coiled tubing. Coiled tubing is run into a hole with a jetting tool on the end. When the tool reaches its target, the chemical is pumped through the pipe and is jetted directly onto the damaged area.

The development of effective corrosion inhibitors and the use and further development of acid treatment (acidizing) of oil and gas wells proliferated and led to the establishment of the well stimulation services industry.

Acid washing is most commonly performed with hydrochloric acid (HCl) mixtures, but other acids can be used to clean out scale (such as calcium carbonate), rust, and other debris restricting flow in the well. Matrix and fracture acidizing are both formation treatments. The acid treatment is injected below the formation, fracturing pressure. Acidizing, or acid treatment, involves pumping acid into a wellbore or geologic formation that is capable of producing oil and/or gas. In fracture acidizing, acid is pumped above the formation, fracturing pressure. The purpose of fracture acidizing is to restore or improve an oil or gas well's productivity by dissolving material in the productive formation that is restricting oil and water flow, or to dissolve the formation rock itself to enhance existing flow paths, or to create new oil and water flow paths to the wellbore.

There are applications in which a solids-free liquid is used to “complete” an oil or gas well. In these applications, the fluid is placed in the well to facilitate final operations prior to initiation of production. The fluid is meant to control a wellbore pressure should downhole hardware fail without damaging the producing formation or completion components.

Completion fluids are typically brines (chlorides, bromides and formates) but, in theory, could be any fluid of proper density and flow characteristics. The fluid should be chemically compatible with the reservoir formation and fluids and is typically filtered to a high degree to avoid introducing solids to the near-wellbore area. Seldom is a regular drilling fluid suitable for completion operations due to its solids content, pH and ionic composition.

Sometimes brine will be lost to the formation if the hydrostatic pressure of the brine is higher than the wellbore pressure. If the weight of the brine has a higher hydrostatic pressure compared to the wellbore pressure, the brine will go into the formation. If the wellbore pressure is higher than the hydrostatic pressure of the brine, the well fluids will move upward towards the surface. Additives can be added to the brine to reduce or stop the fluid losses. The brine and additives return to the surface facility, where separation equipment is needed to remove the hydrocarbons from the brine prior to discharging the water into the sea or injecting it into the well.

Fine solid particles present in crude oil are capable of effectively stabilizing emulsions. The effectiveness of these solids in stabilizing emulsions depends on factors such as solid particle size, interparticle interaction, and wettability of the solids.

Solid particles stabilize emulsions by diffusing into the oil/water interface, where they form rigid films that can sterically inhibit the coalescence of emulsion droplets. Furthermore, solid particles at the interface may be electrically charged, which may also enhance the stability of the emulsion. Particles must be much smaller than the size of the emulsion droplets to act as emulsion stabilizers. Typically, these solid particles are submicron to a few microns in diameter.

The wettability of the particles plays an important role in emulsion stabilization. Wettability is the degree to which a solid is wetted by oil or water when both are present. If the solid remains entirely dry in the oil or water phase, it will not be an emulsion stabilizer. For the solid to act as an emulsion stabilizer, it must be present at the interface and must be wetted by both the oil and water phases. In general, oil-wet solids stabilize a water-in-oil emulsion. Oil-wet particles preferentially partition into the oil phase and prevent the coalescence of water droplets by steric hindrance. Similarly, water-wet solids stabilize a water-continuous or an oil-in-water emulsion.

When solids are wetted by the oil and water (intermediate wettability), they agglomerate at the interface and retard coalescence. These particles must be repositioned into either the oil or water for coalescence to take place. This process requires energy and provides a barrier to coalescence.

The effectiveness of colloidal particles in stabilizing emulsions depends largely on the formation of a densely packed layer of solid particles (film) at the oil/water interface. This film provides steric hindrance to the coalescence of water droplets. The presence of solids at the interface also changes the rheological properties of the interface that exhibits viscoelastic behavior. This affects the rate of film drainage between droplets and affects the displacement of particles at the interface. It has also been demonstrated that for asphaltenes and waxes to be effective emulsifiers, they must be present in the form of finely divided submicron particles.

The present invention is distinguished from the prior art for the following reasons:

The present invention is distinguished from Ohsol (U.S. Pat. No. 4,938,876) as Ohsol does not disclose the use of a multicompartment separator tank. Furthermore, Ohsol does not utilize fluids at an ambient air temperature, unlike the present invention.

The present invention is distinguished from Moene (US Pat. App. 20140008271) as Moene does not disclose the use of a multicompartment separator tank. Furthermore, Moene does not utilize fluids at an ambient air temperature, unlike the present invention.

The present invention is distinguished from Wu (CN203284265) as Wu does not disclose the use of a multicompartment separator tank.

The present invention is distinguished from Govindan (U.S. Pat. No. 9,266,748) as 1) Govindan requires a heat exchange with a fluid, whereas the present invention utilizes ambient air temperature with no heat exchange; 2) Govindan is very complicated and requires many expensive steps for fluid treatment, whereas the present invention provides a simpler and more cost effective fluid treatment process that does not require a fluid heat exchange; and furthermore, 3) Govindan does not teach the use of a multicompartment separator as is claimed in the present invention.

The present invention is distinguished from Blazejczak (U.S. Pat. No. 4.990246). as Blazejczak requires 1) a gas covering, 2) stators and rotors, and 3) a skimmer. The present invention is a multicompartment separator that specifically avoids the need for those aspects of Blazejczak and is therefore an improvement regarding efficiency and cost over Blazejczak.

### SUMMARY

In some embodiments, the present invention is a system for deck drainage treatment comprising: FPSO fluid compartments; a pump; a hydrocyclone desander capable of desanding; and/or a non-consumable or consumable mechanical solids filter capable of mechanical filtration; and a membrane filtration unit that is a membrane unit with a polymeric membrane filter; and some embodiments contain a Granular Activated Carbon housed in bulk vessels or cartridges used to remove water soluble organics if present in the fluids; wherein fluid is passed into said FPSO fluid compartments, said fluid is then capable of being pumped via said pump to either said hydrocyclone desander for desanding and/or said non-consumable or consumable mechanical solids filter for mechanical filtration; said fluid is then passed into said membrane unit that is a membrane unit with a polymeric membrane filter; and in some embodiments, Granular Activated Carbon housed in bulk vessels or cartridges is used to remove water soluble organics if present in the fluids; and wherein water derived from said fluid passing into said FPSO fluid compartments, said fluid is then capable of being pumped via said pump to either said hydrocyclone desander for desanding and or said non-consumable or consumable mechanical solids filter for mechanical filtration; said fluid is then passed into said membrane filtration unit which is a membrane filtration unit with a polymeric membrane filter where clean permeate is discharged, and in some embodiments, Granular Activated Carbon housed in bulk vessels or cartridges is used to remove water soluble organics if present in the fluids, and the concentrated fluid is recirculated to said FPSO fluid compartment. In some embodiments of the present invention, the present invention treats fluids at ambient air temperature. In some embodiments of the present invention, the present invention utilizes a multicompartment separator that does not have rotors or skimmers.

In some embodiments, the present invention is a system for Enhanced Oil Recovery (EOR) Polymer Flood and Alkali Surfactant Polymer (ASP) treatment comprising: a separator or holding tank; a pump; a hydrocyclone desander capable of desanding; a non-consumable or consumable mechanical solids filter capable of mechanical filtration; and a membrane filtration unit that is a membrane unit with a polymeric membrane filter; wherein fluid passed into said separator or holding tank enters through said intake valve and is treated for bulk oil, gas and solids separation; said fluid is then capable of being pumped via said pump to either said hydrocyclone desander for desanding and/or said non-consumable or consumable mechanical solids filter for mechanical filtration; said fluid is then passed into said membrane filtration unit which is a membrane filtration unit with a polymeric membrane filter; and wherein water derived from said passing into said separator or holding tank enters through said intake valve and is treated for bulk oil, gas and solids separation; said fluid is then capable of being pumped via said pump to either said hydrocyclone desander for desanding and/or said non-consumable or consumable mechanical solids filter for mechanical filtration; said fluid is then passed into said membrane filtration unit which is a membrane filtration unit with a polymeric membrane filter where clean permeate is discharged, and the concentrated fluid is recirculated to said pump. In some embodiments of the present invention, the present invention treats fluids at ambient air temperature. In some embodiments of the present invention, the present invention utilizes a multicompartment separator that does not have rotors or skimmers.

In several embodiments of the present invention, one aspect is to combine multiple technologies into one container: a pump; a hydrocyclone desander capable of desanding; a non-consumable or consumable mechanical solids filter capable of mechanical filtration; and a membrane filtration unit with a polymeric membrane filter. This will allow for the equipment to be ready for service faster than that of any other companies on the market. All other companies utilize modular equipment in this market, which takes many hours to rig up and have ready for service. In several embodiments of the present invention, materials such as filters are reusable after cleaning.

In some embodiments, the tank, typically in the hull, will send water via a pump through a desanding hydrocyclone, and/or solids filter, and oil and solids removal membrane filter. The membrane is a crossflow technology which consists of recirculation loop from pump through the membrane and back into the tank in the hull of the ship. Crossflow is needed to keep solid contaminates away from the membrane surface. Adding induced gas or dissolved gas can increase the agitation inside of the membrane, as well as decrease the overall viscosity of the raw fluids, which will help in keeping the solids from attaching to the membrane surface. In some embodiments of the present invention, the present invention treats fluids at ambient air temperature. In some embodiments of the present invention, the present invention utilizes a multicompartment separator that does not have rotors or skimmers.

In some embodiments, the fluids resulting from acid stimulation, or well completions, (from a single well or multiple wells) are sent to a three-phase separation vessel to release the lighter hydrocarbons gas phase, heavier hydrocarbons oil phase, and water and solids. The bulk of the heavy hydrocarbons and most of the light hydrocarbons will be removed in this vessel. The remaining hydrocarbons typically range in concentrations from 200 mg/L to 5,000 mg/L, depending on the emulsified state of the hydrocarbons, and will be sent to a lower pressure multipurpose separations vessel (this can be either a pressure vessel or an atmospheric vessel). Different applications will have different amounts of oil in the water. The more the oil is emulsified, the more oil will be in the water after it leaves. A three-phase separator can be used in some embodiments. In some embodiments of the present invention, the present invention treats fluids at ambient air temperature. In some embodiments of the present invention, the present invention utilizes a multicompartment separator that does not have rotors or skimmers.

In some embodiments, this vessel, tank, or multicompartment separator typically will have multiple compartments, including, but not limited to, an inlet compartment containing an inlet diffuser designed to further degas fluids and/or mix chemicals if they are required, a recirculation compartment, a clean water compartment, and an oil compartment. The water phase from this vessel, tank, or multicompartment separator will be pumped through a desanding hydrocyclone, and/or solids filter, and an oil and solids removal membrane filter. In some embodiments of the present invention, the present invention treats fluids at ambient air temperature. In some embodiments of the present invention, the present invention utilizes a multicompartment separator that does not have rotors or skimmers.

In some embodiments, the membrane is a crossflow technology which consists of a circulation loop from a pump through a membrane and back into the suction of the pump. Crossflow is needed to keep solid contaminates away from membrane surface. Adding induced gas or dissolved gas will increase the agitation inside of the membrane, as well as decrease the overall viscosity of the raw fluids, which will help in keeping the solids from attaching to the membrane surface.

In some embodiments of the present invention, one aspect of the present invention is to combine multiple technologies into one container including, but not limited to, centrifugal pumps with variable speed drive, desander hydrocyclone and/or mechanical solids filters, and oil and solids removing membranes. This will allow for the equipment to be ready for service faster than that of any other companies on the market. All other companies have modular equipment in this market, which takes many hours to rig up and have ready for service. In some embodiments of the present invention, the present invention treats fluids at ambient air temperature. In some embodiments of the present invention, the present invention utilizes a multicompartment separator that does not have rotors or skimmers.

### BRIEF DESCRIPTION OF THE DRAWINGS

For a more complete understanding of the present disclosure and the advantages thereof, reference is now made to the following descriptions to be taken in conjunction with the accompanying drawings describing specific embodiments of the disclosure, wherein:

FIG. 1 is a flow diagram of one embodiment of the present invention for acid and completion treatment.

FIG. 2 is a flow diagram of one embodiment of the present invention for FPSO Slop Water treatment.

FIG. 3 is a flow diagram of another embodiment of the present invention for EOR Polymer Flood and ASP treatment, deck drainage treatment or FPSO slop water treatment.

FIG. 4 illustrates one embodiment of the present invention for EOR Polymer Flood and ASP treatment, deck drainage treatment or FPSO slop water treatment.

FIG. 5 is a flow diagram of one embodiment of the present invention for acid and completion treatment, EOR Polymer Flood and ASP treatment, deck drainage treatment or FPSO slop water treatment.

FIG. 6 is a flow diagram of one embodiment of the present invention for EOR Polymer Flood and ASP treatment, deck drainage treatment or FPSO slop water treatment.

FIG. 7 is a flow diagram of another embodiment of the present invention for EOR Polymer Flood and ASP treatment, deck drainage treatment or FPSO slop water treatment.

FIG. 8 illustrates one embodiment of the present invention for EOR Polymer Flood and ASP treatment, deck drainage treatment or FPSO slop water treatment.

FIG. 9 illustrates one embodiment of the present invention for an entire fluid treatment system.

FIG. 10 illustrates one embodiment of the present invention regarding a membrane filter containment unit.

FIG. 11 illustrates one embodiment of the present invention regarding membrane filtration.

FIG. 12 illustrates one embodiment of the present invention regarding double tank solids filtration.

FIG. 13 illustrates one embodiment of the present invention regarding a centrifugal pump with a header.

FIG. 14 illustrates one embodiment of the present invention regarding an activated carbon filtration vessel.

FIG. 15 illustrates one embodiment of the present invention for an entire fluid treatment system.

### DETAILED DESCRIPTION

One or more illustrative embodiments incorporating the invention disclosed herein are presented below. Applicant has created a revolutionary industrial water cleaning process, system and method.

In the following description, certain details are set forth such as specific quantities, sizes, etc. to provide a thorough understanding of the present embodiments disclosed herein. However, it will be evident to those of ordinary skill in the art that the present disclosure may be practiced without such specific details. In many cases, details concerning such considerations and the like have been omitted inasmuch as such details are not necessary to obtain a complete understanding of the present disclosure and are within the skills of persons of ordinary skill in the relevant art.

Referring to the drawings in general, it will be understood that the illustrations are for the purpose of describing embodiments of the disclosure and are not intended to be limiting thereto. Drawings are not necessarily to scale, and arrangements of specific units in the drawings can vary.

Most of the terms used herein will be recognizable to those of ordinary skill in the art, and it should be understood that, when not explicitly defined, terms should be interpreted as adopting a meaning presently accepted by those of ordinary skill in the art. In cases where the construction of a term would render it meaningless or essentially meaningless, the definition should be taken from Webster's Dictionary 2020. Definitions and/or interpretations should not be incorporated from other patent applications, patents, or publications, related or not, unless specifically stated in this specification or if the incorporation is necessary for maintaining validity.

Certain terms are used in the following description and claims to refer to system components. As one skilled in the art will appreciate, different persons may refer to a component by different names This document does not intend to distinguish between components that differ in name but not function. The drawing figures are not necessarily to scale. Certain features of the invention may be shown exaggerated in scale or in somewhat schematic form, and some details of conventional elements may not be shown, all in the interest of clarity and conciseness. As utilized herein, the term “mechanical solids filter” is defined as “a type of filter that is primarily designed to remove suspended solid particles.” As utilized herein, the term “consumable solids filter” is defined as “a depletable solids filter.” As utilized herein, the term “non-consumable solids filter” is defined as “a non-depletable solids filter.” As utilized herein, the term “ambient” is defined as “relating to the immediate surroundings of something.” In some embodiments, the ambient temperature of the fluid or water can be affected by the location of water origination, such as, but not limited to, underground or above ground and can possibly have a temperature range of 50-175 degrees Fahrenheit. In several embodiments, the ambient temperature is the temperature of the fluid as it enters the present inventive system.

Although several preferred embodiments of the present invention have been described in detail herein, the invention is not limited hereto. It will be appreciated by those having ordinary skill in the art that various modifications can be made without materially departing from the novel and advantageous teachings of the invention. Accordingly, the embodiments disclosed herein are by way of example. It is to be understood that the scope of the invention is not to be limited thereby.

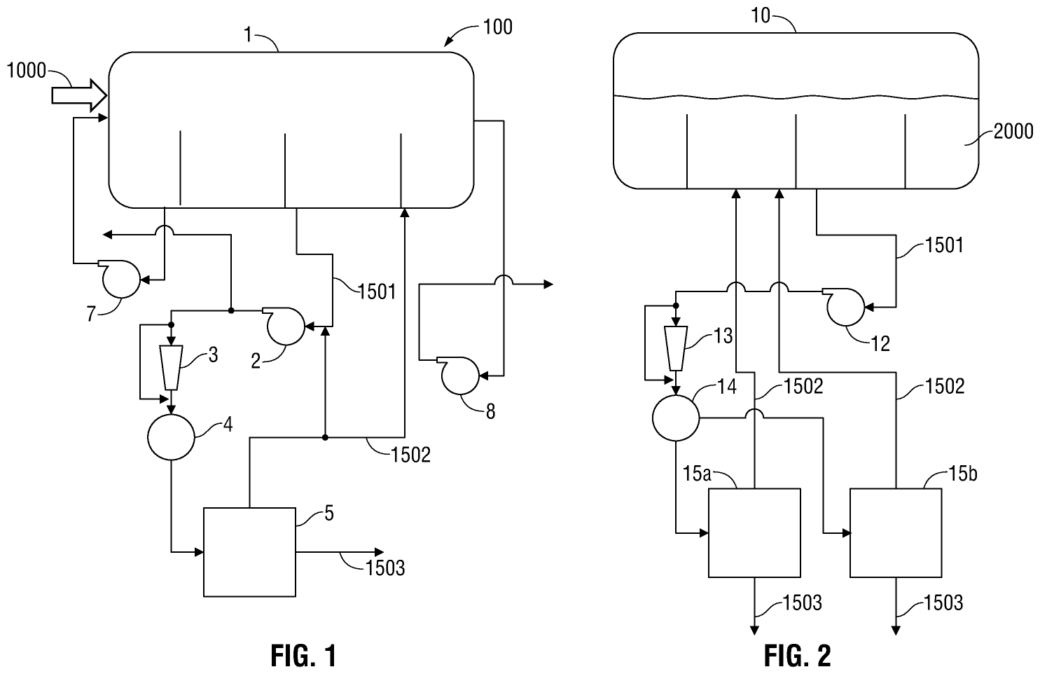

FIG. 1 illustrates one embodiment of the present invention 100 in a flow chart for acid and completion treatment. As shown, fluid 1000 can enter multicompartment separator 1. In several embodiments, the fluid 1000 is at ambient temperature. In several embodiments of the present invention, as shown in FIGS. 1-15 the said ambient temperature of the fluid 1000 is in a temperature range of 50-175 degrees Fahrenheit. In several embodiments, multicompartment separator 1 lacks any rotors and/or skimmers. In several embodiments, within multicompartment separator 1, the bulk of the free oil will separate by gravity and then be skimmed by an oil skim pipe into the oil compartment. In several embodiments, the water or fluid 1000 will weir. The separation tank takes in total fluids which contain oil, water and solids. Shown, in one embodiment is post gravity separation in separation vessel 1 and the inlet fluid 1000 is fluid 1501. In several embodiments, after the oil floats to the top of separation tank 1 and is skimmed off into the oil compartment plates from the last water compartment by pump 2 into hydrocyclone desander 3 or mechanical solids removal unit/filter 4. The remaining hydrocarbons typically range in concentrations from 200 mg/L to 5000 mg/L (free oil will float up to the top of the multipurpose separation vessel and will be skimmed off of fluid as described in paragraph above), depending on the emulsified state of the hydrocarbons, and will be sent to a pressure multipurpose separations vessel or tank (this can be either pressure vessel or atmospheric vessel).

In several embodiments, the hydrocyclone desander 3, or solids removal filter 4, will receive water or fluid 1501 containing solids and hydrocarbons; the hydrocarbons can be free or emulsified in the water or fluid 1501. In several embodiments, pump 2 is a pump as known in the art for pumping water or fluids in an industrial cleaning process. In some instances, the water or fluid pumped by pump 2 can circumvent hydrocyclone desander 3 and be pumped directly into non-consumable or consumable mechanical solids removal filter 4. In several embodiments, the water can be pumped into non-consumable or consumable mechanical solids filter 4 after being processed by hydrocyclone desander 3.

In many embodiments, desanding hydrocyclone 3, called a desander, offers the highest throughput-to-size ratio of any solids-removal equipment. Generally, hydrocyclones operate by pressure drop. The feed, a mixture of liquids and solids, enters the hydrocyclone through the volute inlet at the operating feed pressure. The change in flow direction forces the mixture to spin in a radial vortex pattern. Because of the angular acceleration of the flow pattern, centrifugal forces are imparted on the solid particles, forcing them toward the internal wall of the cone. The solids continue to spin in a radial vortex pattern, down the length of the cone, and discharge through the apex, creating the underflow stream. Because of cone convergence, the liquid flow is reversed and sent upward through the vortex finder to create the overflow stream. The solids that exit through the apex collect into an accumulation chamber and are periodically purged, while the overflow discharges continually.

In many embodiments, the water or fluid from non-consumable or consumable mechanical solids filter 4 will flow into membrane filtration unit 5. After being processed by membrane filtration unit 5, the water or fluid can be broken down into two fluids concentrate, fluid 1502 and permeate 1503. It can then be discharged, and the water and oil that does not pass-through membrane filtration unit 5 can then be recirculated back to pump 2 to further be processed through hydrocyclone desander 3, or non-consumable/consumable mechanical solids filter 4, or both. Recirculation pump 7 can recirculate fluids from multicompartment separator that may need chemical treatment and agitation (the amount of agitation may vary) to help break oil in water emulsions. Oil in water emulsion is when oil is in the form of very small and stable oil droplets in the water or fluid due to mechanical shearing or through chemical process.

In several embodiments, the membrane filtration unit 5 utilizes a crossflow technology which consists of a recirculation loop from pump 2 through the membrane filtration unit 5 and back into the suction of the pump 2; occasionally this fluid will need to be replaced with fresh fluids from separation vessel or tank to reduce the oil content that has increased during the concentration process. In several embodiments, crossflow is needed to keep contaminates away from membrane surface 5. Adding induced gas or dissolved gas can increase the agitation inside of the membrane 5 as well as decrease the overall viscosity of the raw fluids 1000.

In several embodiments, the water or fluid to be treated 1000 will flow into a vessel, tank or multicompartment separator 1 that may have multiple compartments including, but not limited to, an inlet compartment containing an inlet diffuser designed to further degas fluids and/or mix chemicals if they are required, a recirculation compartment, a clean water compartment, and an oil compartment. The water or fluid from this vessel or tank will be pumped through a desanding hydrocyclone 3, and/or solids filter 4, and membrane unit 5.

FIG. 2 shows another embodiment of the present invention for FPSO slop water treatment. As shown, compromised water 2000 from FPSO fluid compartment 10 will be pumped by pump 12 into hydrocyclone desander 13. In several embodiments, compromised water 2000 will be at ambient temperature. Post gravity separation in separation vessel 10, the inlet fluid 2000 is fluid 1501. Pump 12 is a pump as known in the art for pumping water or fluids in an industrial cleaning process. In some instances, the water or fluids pumped by pump 12 can circumvent hydrocyclone desander 13 and be pumped directly into non-consumable or consumable mechanical solids filter 14. In several embodiments, the water or fluids 2000 can be pumped into non-consumable or consumable mechanical solids filter 14 after being processed by hydrocyclone desander 13. In many embodiments, solids removal vessel 14 will receive water containing solids and hydrocarbons; the hydrocarbons can be free or emulsified in the water. In many embodiments, the water from non-consumable or consumable mechanical solids filter 14 will flow into a membrane filtration unit 15a and/or 15b. After being processed by membrane filtration unit 15a and/or 15b, the water can then be discharged, and the water and oil that does not pass-through membrane filtration units 15a and 15b can then be recirculated back to fluid holding tank 10 to be further processed through hydrocyclone desander 13 and/or non-consumable or consumable mechanical solids filter 14, or both. After being processed by membrane filtration unit 15a or 15b the water, or fluid, 1500 can be broken down into two fluids, concentrate fluid 1502 and permeate 1503.

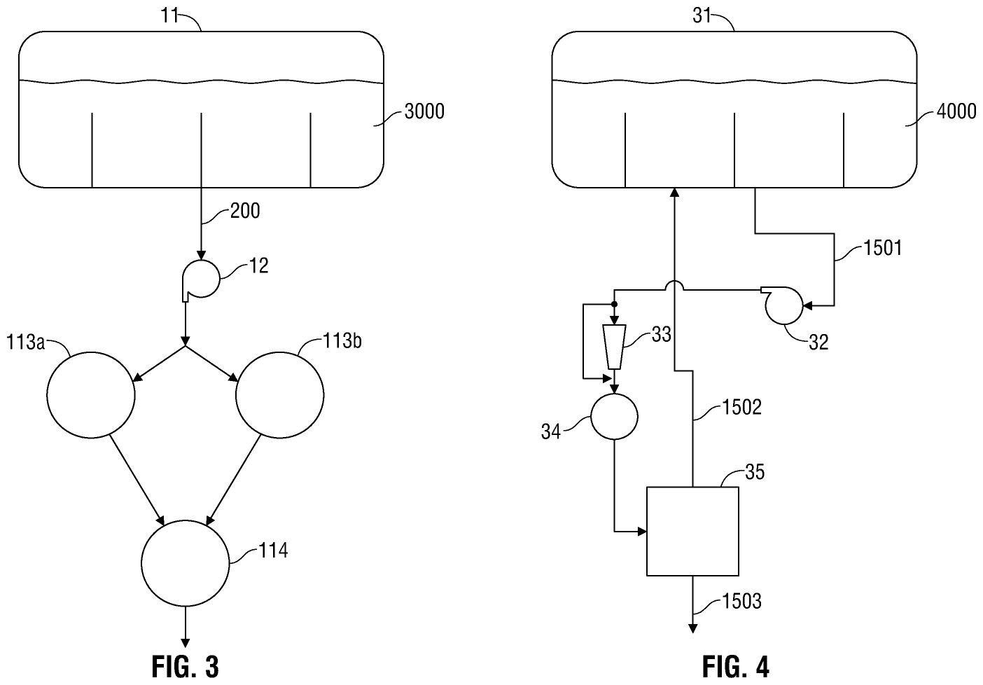

FIG. 3 shows one embodiment of an alternative for EOR Polymer Flood and ASP, deck drainage treatment or FPSO slop water treatment in one embodiment of the present invention. In this embodiment, fluid 3000 leaves FPSO fluid compartment 11. In several embodiments, fluid 3000 is at ambient temperature. Post gravity separation in separation vessel 11, the inlet fluid 3000 is fluid 200. In several embodiments, the contaminated water 200 from one of the fluid compartments of 11 is pumped via pump 12 into either compressible oil coalescing and removal unit 113a or 113b, for compression oil coalescing and removal. In several embodiments, after treatment in removal units 113a or 113b, the treated water 200, if needed, is then sent into vertical or horizontal coalescing media unit 114 so that oil 300 (not shown on drawing) is then recycled for use.

In several embodiments, the water from the slop water tank 11 will be pumped through the compressible oil coalescing and removal units 113a and/or 113b that will receive water containing solids and hydrocarbons. The hydrocarbons can be free or emulsified in the water. During the removal of the hydrocarbons, the media is in a compressed state; different compressions allow for finer oil droplet removal, but the increased compression sacrifices surface area. During the cleaning of the media, after the media is saturated, the media is decompressed and agitated to allow flushing of the contaminates out from the oil coalescing media. The hydrocarbons are removed by flowing the oily water though a media consisting of polymeric fiber balls where the polymer attracts the oil and promotes coalescing. Once the oil droplets have increased in size, the velocities will push the large oil droplets through and out of the media, where it will float to the top of the vessel. The clean water will be discharged from the side of the hydrocarbon removal vessel.

FIG. 4 illustrates one embodiment of the present invention for EOR Polymer Flood and ASP, deck drainage treatment or FPSO slop water treatment. As shown, water or fluid 4000 from one of the deck drainage holding compartments 31 can be pumped by pump 32 into hydrocyclone desander 33 and/or non-consumable or consumable mechanical solids filter 34. Post gravity separation in separation vessel 31, the inlet fluid 4000 is fluid 1501. In several embodiments, water or fluid 4000 will be at ambient temperature. The water or fluid 1501 (this water can be mostly rainwater and water used to clean deck) will then flow into membrane filtration unit 35. Water then passes through the membrane filtration unit 35 to be discharged, and the water and oil that does not pass through the membrane will be recirculated into one of the multiple fluid holding compartments of 31. After being processed by membrane filtration unit 35, the water or fluid 1501 can be broken down into two fluids, concentrate fluid 1502 and permeate 1503.

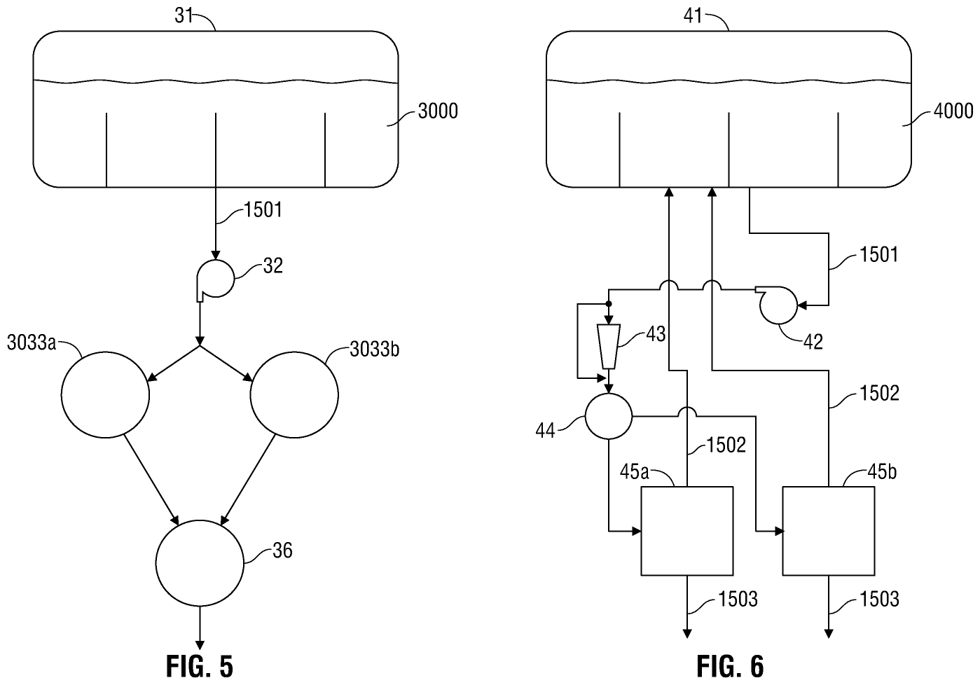

FIG. 5 illustrates an alternative embodiment for acid and completion EOR Polymer Flood and ASP, deck drainage treatment or FPSO slop water treatment. Post gravity separation in separation vessel 31, the inlet fluid 4000 is fluid 1501. The oil that is coalesced will be separated and returned to a storage container. In several embodiments, water/fluid 4000 is at ambient temperature. As shown, water/fluid 3000 from one of the deck drainage compartments of 31 will be pumped by pump 32 (if pressure boost is needed) into compressible solids filter 3033a and 3033b. If needed, the water/fluid 3000 will then flow into said vertical or horizontal polishing media unit 36 and will then be discharged.

In several embodiments, the water to be treated will flow into a vessel upstream of the compressible coalescing media 3033a and 3033b. The water will flow through the coalescing media 3033a or 3033b in a compressed state where the solids will be removed, and the oil will be coalesced. The coalesced oil will separate by gravity separation alone or with micro bubbles to enhance the separation. The oil will be skimmed, and the water will be removed from the side of the vessel.

In several embodiments, vertical or horizontal polishing unit 36 is designed to remove the residual oil present in the fluids. The fluid with free and emulsified organics will flow from the inside inner core, through the media and out the outer core. The organics will be coalesced to form large oil droplets so that they will separate from the water and float to the top of the vessel or container the fluid is flowing into. The oil drops are large enough to separate from the water and will not re-disperse into the water.

In several embodiments, the vertical or horizontal polishing unit 36 has canisterized media in between that the fluid flows through. This media is highly compressed to a specific hydraulic pressure and consists of an exact blend of fibers and proprietary polymers. The hydrocarbons are removed by flowing the oily water though a media consisting of a polymer and fiber where the polymer attracts the oil and promotes coalescing. Once the oil droplets have increased in size, the velocities will push the large oil droplets through and out of the media where it will float to the top of the vessel. The clean water will be discharged from the bottom of the hydrocarbon removal vessel.

FIG. 6 illustrates one embodiment of the present invention for EOR Polymer Flood and ASP, deck drainage treatment or FPSO slop water treatment. As shown, water or fluid 4000 from one of the multicompartment separators of holding tank 41 will be pumped by pump 42 into hydrocyclone desander 43 and/or non-consumable or consumable mechanical solids filter 44. Post gravity separation in separation vessel 41, the inlet fluid is fluid 1501. In several embodiments, the fluid 4000 is at ambient temperature. In several embodiments, multicompartment separator 41 lacks any rotors or skimmers. The water or fluid will then flow into membrane filtration units 45a and/or 45b. From the membrane filtration units 45a and/or 45b, the water or fluid that passes through the membrane filtration unit will be discharged, and the water and oil that does not pass through the membrane filtration unit will be recirculated into one of the multiple fluid holding compartments of 41. After being processed by membrane filtration units 45a and/or 45b, the water or fluid can be broken down into two fluids, concentrate fluid 1502 and permeate 1503.

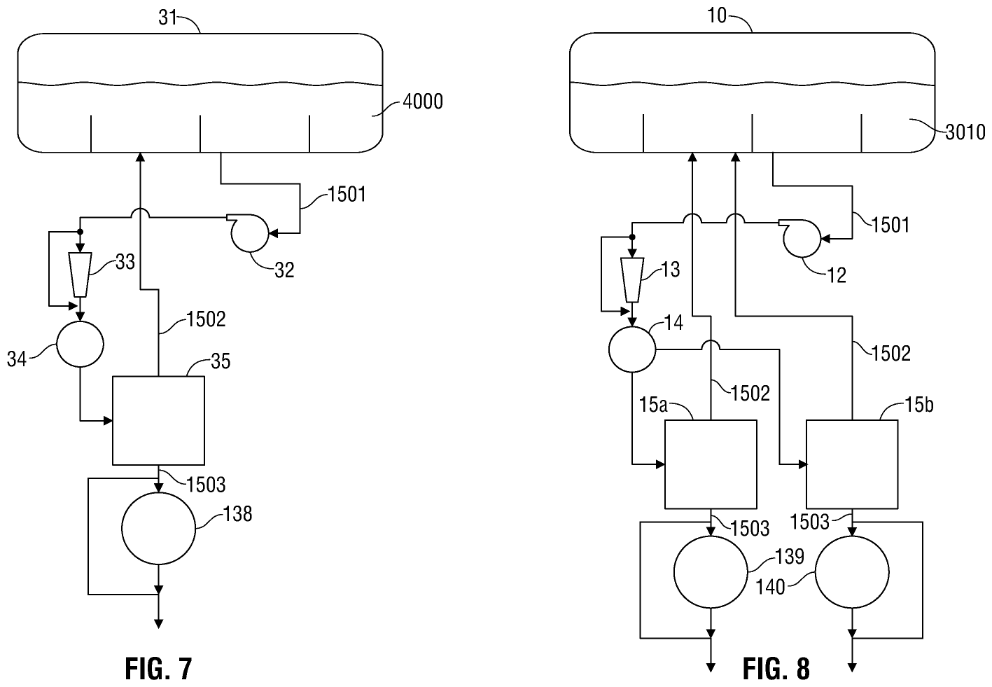

FIG. 7 illustrates one embodiment of the present invention for EOR Polymer Flood and ASP, deck drainage treatment or FPSO slop water treatment. As shown, water or fluid 4000 from one of the deck drainage holding compartments of 31 will be pumped by pump 32 into hydrocyclone desander 33 and/or non-consumable or consumable mechanical solids filter 34. Post gravity separation in separation vessel 31, the inlet fluid 4000 is fluid 1501. In several embodiments, the fluid 4000 is at ambient temperature. In several embodiments, multicompartment separator 31 lacks any rotors or skimmers. In several embodiments, the water or fluid 4000 will then flow into membrane filtration unit 35. Water or fluid 4000 then passes through the membrane filtration unit to be discharged, and the water and oil that does not pass through the membrane filtration unit 35 will be recirculated into one of the multiple fluid holding compartments of 31. In several embodiments, after the water or fluid 4000 flows into the membrane filtration unit 35, it will then flow into granular activated carbon filter, housed in bulk vessels or cartridges 138, used to remove water soluble organics if present in the water or fluids. After being processed by membrane filtration unit 35, the water or fluid 1501 can be broken down into two fluids, concentrate fluid 1502 and permeate 1503.

FIG. 8 shows another embodiment of the present invention for EOR Polymer Flood and ASP, deck drainage treatment or FPSO slop water treatment. As shown, compromised water or fluid 3010 from one of the deck drainage holding compartments will be pumped by pump 12 from FPSO fluid compartment 10 into hydrocyclone desander 13. Post gravity separation in separation vessel 10, the inlet fluid 3010 is fluid 1501. In several embodiments, the fluid 3010 is at ambient temperature. In several embodiments, multicompartment separator 10 lacks any rotors or skimmers. In several embodiments, pump 12 is a pump as known in the art for pumping water or fluids in an industrial cleaning process. In some instances, the water pumped by pump 12 can circumvent hydrocyclone desander 13 and be pumped directly into non-consumable or consumable mechanical solids filter 14. In several embodiments, the water can be pumped into non-consumable or consumable mechanical solids filter 14 after being processed by hydrocyclone desander 13. In many embodiments, mechanical solids filter 14 will receive water containing solids and hydrocarbons; the hydrocarbons can be free or emulsified in the fluid or water.

In many embodiments, the water or fluid from non-consumable or consumable mechanical solids filter 14 will flow into membrane filtration units 15a and/or 15b. After being processed by membrane filtration units 15a and/or 15b, the water can then be discharged, and the water and oil that does not pass through membrane filtration units 15a and/or 15b can then be recirculated back to fluid holding tank 10 to be further processed through hydrocyclone desander 13 and/or non-consumable or consumable mechanical solids filter 14, or both. In several embodiments, after the water or fluid flows into the membrane filtration units 15a and/or 15b, it will then flow into granular activated carbon filter, housed in bulk vessels or cartridges 139 or 140, used to remove water soluble organics if present in the fluids. After being processed by membrane filtration units 15a and/or 15b, the water or fluid 1501 can be broken down into two fluids, concentrate fluid 1502 and permeate 1503.

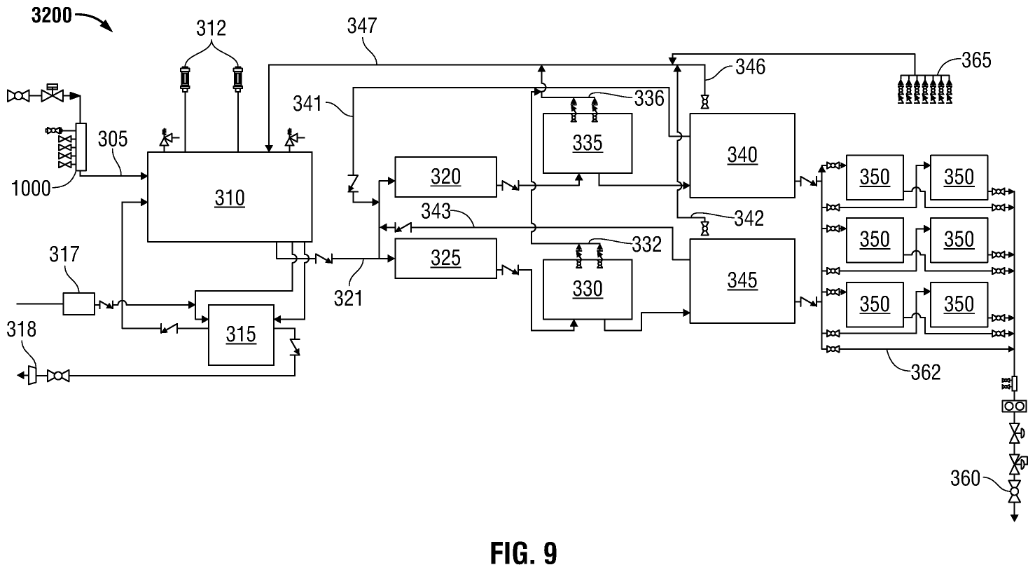

FIG. 9 illustrates one embodiment of the present invention for an entire fluid treatment system as a flow through process 3200. As illustrated, in one embodiment, fluid or water can come from what can be referred to as atmospheric holding tank via fluid flow route line 305 and enter separation tank 310. In several embodiments, multicompartment separation tank 310 is designed with a vent boom option 312. In several embodiments, the fluid 1000 is at ambient temperature. In several embodiments, multicompartment separation tank 310 lacks any rotors or skimmers. Once in the multicompartment separation tank 310, the fluid can be treated with a chemical clarifier 317, and some of the oil can be pumped back to what can be referred to as atmospheric holding tank 318 via pump 315.

In several embodiments, some of the fluid is pumped via line 321 through pumps 320 and/or 325 into solids filter skid 335 and/or 330, respectively. In several embodiments, there are bleed lines 332 and 336 associated with the solids filters skids 330 and/or 335, respectively, to allow for backwash. In some instances, backwash is made with clean permeate, fresh water, or sea water depending on application, and bleed may be transported back to the multicompartment separator tank 310 through bleed line 347.

In several embodiments, after the solids are filtered in the solids filter skids 330 and/or 335, the fluid will flow into the membrane filters 340 and/or 345. In several embodiments, there are bleed lines 342 and 346 associated with the membrane filters 340 and/or 345 (in some instances spiral wound polymeric membranes, hollow fiber membranes, and/or ceramic or flat sheet membranes) to allow for backwash and bleed to be transported back to the multicompartment separator tank 310 through bleed line 347. In several embodiments, bleed line 347 has a bleed header 365 (in some instances either hoses or pipe tied in together to comingle fluids into one line) attached before bleed lines 342 and 346. In several embodiments, there are two concentrated recirculation lines 341 and 343 which run from membrane filters 340 and 345 back to the separator pump line 321. In some instances, this line is used to feed suction of second pump to keep the pressure and flow rate needed to flow fluid through the membrane filters 340 and 345.

In several embodiments, after the fluid passes through the membrane filters 340 and/or 345, it is then cycled through the carbon filters 350 and then to the overboard, or egress line, 360. In some embodiments, there is a bypass line 362 in which fluid can bypass the carbon filters 350.

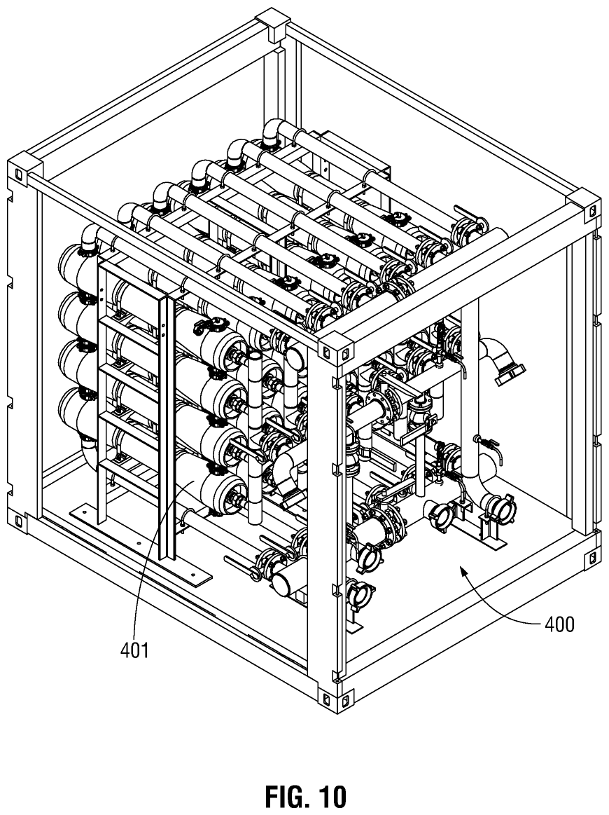

FIG. 10 illustrates one embodiment of a membrane containment vessel of the present invention. As shown is one embodiment of membrane containment vessel 400 with several membrane units 401. In several embodiments, centrifugal pumps are the most commonly used kinetic-energy pump in the present invention. Centrifugal force pushes the liquid outward from the eye of the impeller where it enters the casing. Differential head can be increased by turning the impeller faster, using a larger impeller, or by increasing the number of impellers. The impeller and the fluid being pumped are isolated from the outside by packing or mechanical seals. Shaft radial and thrust bearings restrict the movement of the shaft and reduce the friction of rotation.

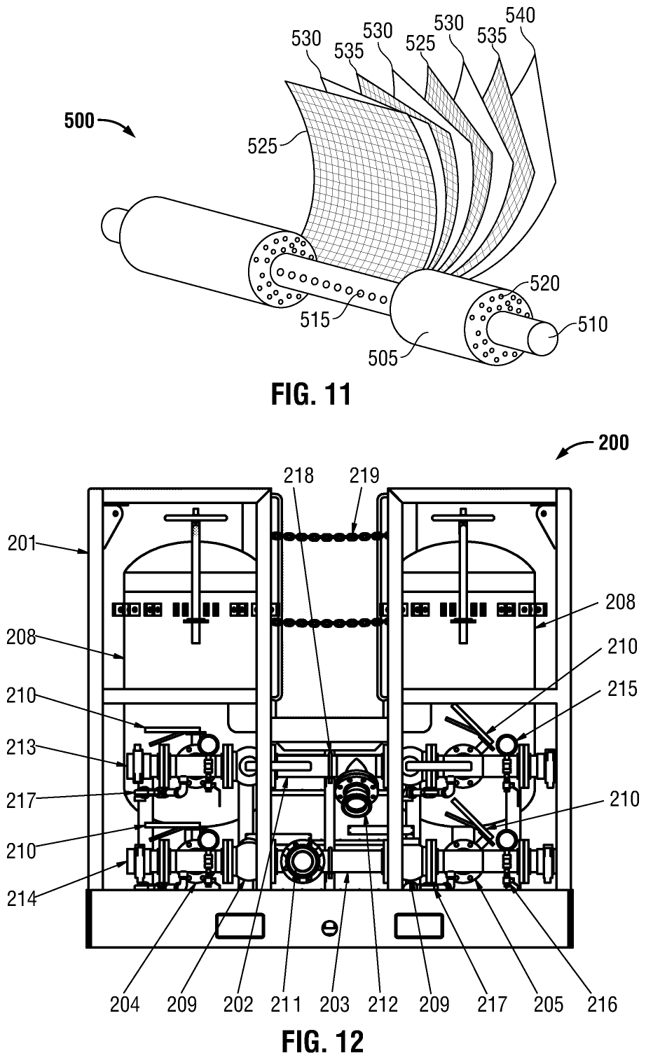

FIG. 11 illustrates one embodiment of the interior of a membrane filter unit 500 of the present invention. As shown, in one embodiment, the membrane filter unit 500 contains a permeate tube 510 with perforations 515 and a wrapped body 505. In several embodiments, the wrapped body 505 consists of multiple layers of materials including layers of a permeate spacer 525, a membrane 530, a feed channel spacer 535, and an outer wrap 540. In several embodiments, the outer wrap 540 is nonpermeable. In some embodiments, the present invention utilizes spiral wound polymeric membranes, hollow fiber membranes, and/or ceramic or flat sheet membranes. In several embodiments, there are several bleed lines 332 and 336 associated with the solids filters 335 and 330 to allow for backwash and bleed to be transported back to the multicompartment separator tank 310 (See FIG. 9).

In several embodiments of the membrane filter (FIG. 11), the spiral wound elements consist of membranes 530, feed channel spacers 535, permeate spacers 525, and a permeate tube 510. In some embodiments, the purpose of the feed channel spacer 535 is to provide space for water or fluid to flow between the membrane surfaces 530 and to allow for uniform flow between the membrane leaves 530.

In some embodiments, fluid travels through the flow channels tangentially across the length of the permeate tube 510. Filtrate will then pass across the membrane surface 530 into the permeate spacer 525, where it is carried down the permeate spacer towards the permeate tube 510. The feed then becomes concentrated at the end of the element body. In some embodiments, filtration is any of various mechanical or physical operations that separate solids and oil from fluids.

FIG. 12 illustrates one embodiment of the dual vessel solids filtration system of the present invention (with one vessel online and one as back up) wherein said filter unit removes solids present in the fluid or water. As shown is one embodiment of a dual vessel, or double tank, filtration system 200. Illustrated is the skid weldment 201, along with piping 202-205. Further shown is grating which may be comprised of fiberglass or other suitable material. Vessel 208 maybe comprised of stainless steel or other suitable materials. Ball valve 209 and butterfly valve 210 are for illustrative purposes but could be any valve suitable for operation. Wingnuts 211 and 213 are illustrated, as are female adaptors or plugs 212 and 214. Further illustrated is pressure gauge 215 and ball valve 216. Ball valve, or another suitable valve, 217 is illustrated, as is U-bolt 218. Chain 219 is also illustrated.

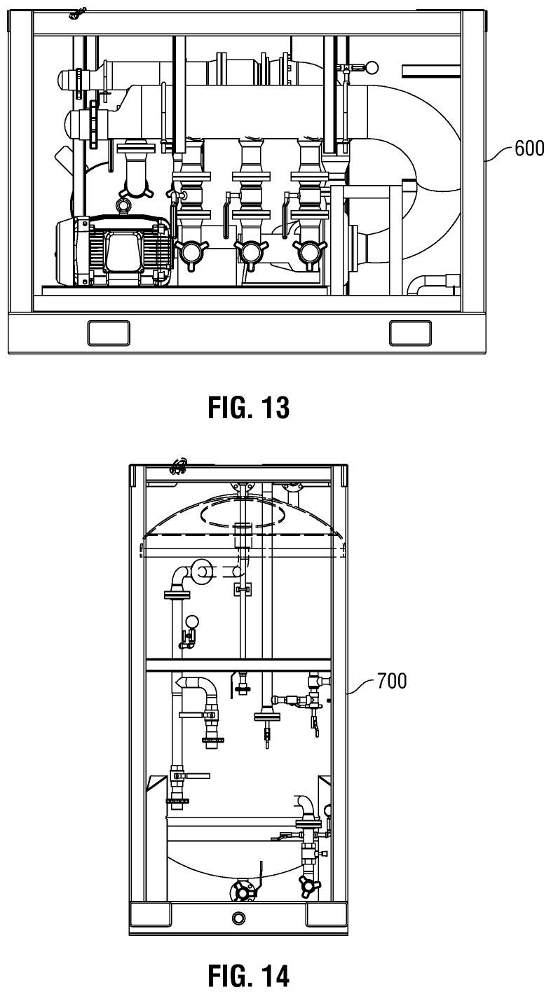

FIG. 13 illustrates one embodiment of a centrifugal pump with a header of the present invention. As shown in FIG. 13 is a centrifugal pump with a header 600.

FIG. 14 illustrates one embodiment a carbon filtration vessel of the present invention. As illustrated is one embodiment of a carbon filtration vessel 700 as is used in the present invention.

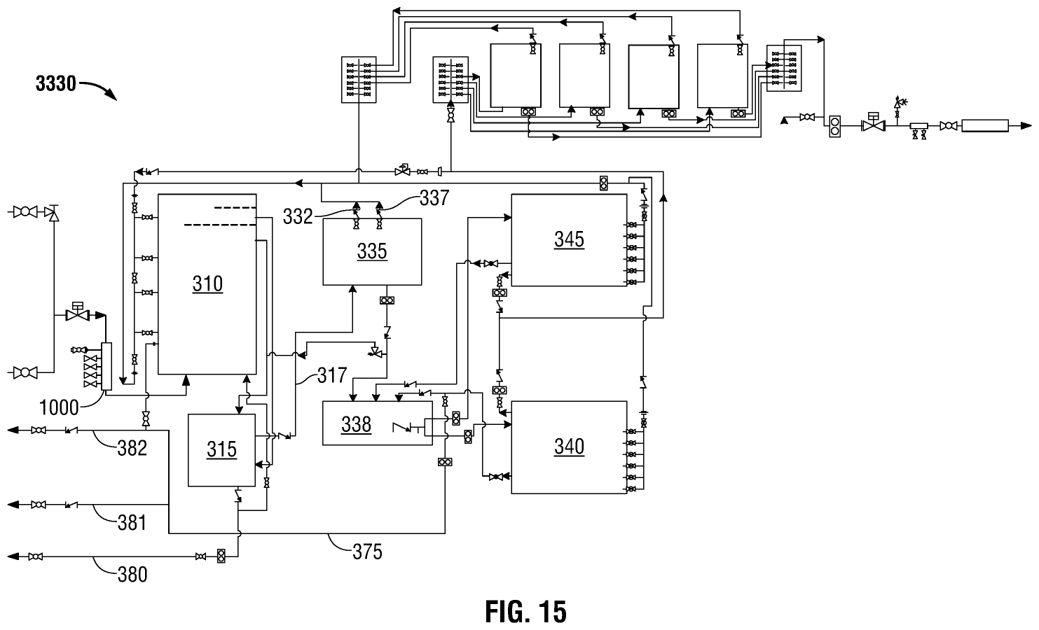

FIG. 15 illustrates one embodiment of an entire fluid treatment system as a flow through process 3330 of the present invention. As illustrated, in one embodiment, fluid or water can come from what can be referred to as atmospheric holding tank line 305 and enter separation tank 310. In several embodiments, separation tank 310 is designed with a vent boom option 312 (See FIG. 9). In several embodiments, the fluid 1000 is at ambient temperature. In several embodiments, multicompartment separation tank 310 lacks any rotors or skimmers. Some oil-containing fluid can also be pumped by pump 315 into an atmosphere holding oil tank via line 380.

In several embodiments, some of the fluid is pumped via line 317 into a solids filter skid 335. In several embodiments, there are bleed lines 332 and 337 associated with the solids filter 335 to allow for oil and air bleed.

In several embodiments, after the solids are filtered in the filter skid 335, the fluid will flow into the membrane filtration units 340 and/or 345 via pump 338. In several embodiments, there are bleed lines 342 and 346 (See FIG. 9) associated with the membrane filter units 340 and/or 345 (in some instances spiral wound polymeric membranes, hollow fiber membranes, and/or ceramic or flat sheet membranes) to allow for backwash and bleed to be transported back to the multicompartment separator tank 310 through bleed line 347. In several embodiments, bleed line 347 has a bleed header 365 (in some instances either hoses or pipe tied in together to comingle fluids into one line) attached before bleed lines 342 and 346. In several embodiments, there are two concentrated recirculation lines 347 and 343 which run from membrane filters 340 and 345 back to the pump line 321. In some instances, this line is used to feed suction of second pump to keep the pressure and flow rate needed to flow fluid through the membranes. Additional bleed lines can be used in some embodiments.

In several embodiments, after the fluid passes through the membrane filter units 340 and/or 345, it is then cycled through fluid line 375 and then pumped into water tank line 382 or atmosphere tank line 381.

In several embodiments, the present invention is a system for acid and completion treatment of a fluid at ambient temperature comprising: a multicompartment separation tank 310 with a vent boom; a chemical clarifier 317; a first pump 320 with first fluid lines; solids filter skid 335 with first fluid bleed lines 336 in fluid communication with said multicompartment separation tank 310 in order to allow for bleed from said solids filter 335 to be transported back to said multicompartment separator tank 310; second fluid lines; membrane filter 340 with second fluid bleed lines 346 in fluid communication with said multicompartment separation tank 310 in order to allow for bleed from said membrane filter 340 to be transported back to said separator tank 310; an egress line 360; wherein a fluid at ambient temperature can enter said multicompartment separation tank 310 and be treated with said chemical clarifier 317; said fluid is then then pumped by said first pump 320 through said first fluid lines into said solids filter skid 335; said fluid is then pumped into said membrane filter 340 through said second fluid lines; and then fluid is pumped into said egress line 360. In several embodiments, two concentrated recirculation lines 341 and 343 run from said membrane filters 340 and 345 back to said first fluid line 321. In several embodiments, a carbon filter 350 is utilized after the fluid passes through said membrane filter 340 and before it enters the egress line 360. In several embodiments, said membrane filter 340 further comprises; a permeate tube 510 with perforation 515 and a wrapped body 505; said wrapped body 505 further comprises; multiple layers of materials including layers of a permeate spacer 525, a membrane 530, a feed channel spacer 535, and an outer wrap 540. In several embodiments, said outer wrap is nonpermeable. This wrap is made of fiberglass, but the membrane can also be made with permeable wrap. In several embodiments, said multicompartment separation tank 310, said pump 320, said solids filter 335, and said membrane filter 340 are encapsulated as a single unit. As shown in FIG. 1, in several embodiments, the fluid can be pumped by pump 2 into hydrocyclone desander 3 or mechanical solids removal unit 4. This mechanical solids removal unit 4 is typically a consumable or nonconsumable media that removes solids. A hydrocyclone 3 can be inserted prior to the mechanical solids removal phase.

In several embodiments, the present invention is a system for Enhanced Oil Recovery Polymer Flood and Alkali Surfactant Polymer with a fluid at ambient temperature comprising: a multicompartment separation tank 310 with a vent boom 312; a chemical clarifier 317; a first pump 320 with first fluid lines; solids filter skid 335 with first fluid bleed lines 336 in fluid communication with said multicompartment separation tank 310 in order to allow for bleed from said solids filter 335 to be transported back to said multicompartment separator tank 310; second fluid lines; membrane filter 340 with second fluid bleed lines 346 in fluid communication with said multicompartment separation tank 310 in order to allow for bleed from said membrane filter 340 to be transported back to said separator tank 310; an egress line 360; wherein a fluid at ambient temperature can enter said multicompartment separation tank 310 and be treated with said chemical clarifier 317; said fluid is then then pumped by said first pump 320 through said first fluid lines into said solids filter skid 335; said fluid is then pumped into said membrane filter 340 through said second fluid lines; and then fluid is pumped into said egress line 360. In several embodiments, two concentrated recirculation lines 341 and 343 run from said membrane filters 340 and 345 back to said first fluid line 321. In several embodiments, a carbon filter 350 is utilized after the fluid passes through said membrane filter 340 and then to the egress line 360. In several embodiments, said membrane filter 340 further comprises; a permeate tube 510 with perforation 515 and a wrapped body 505; said wrapped body 505 further comprises; multiple layers of materials including layers of a permeate spacer 525, a membrane 530, a feed channel spacer 535, and an outer wrap 540. In several embodiments, said outer wrap is nonpermeable. In several embodiments, said separation tank 310, said pump 320, said solids filter 335, and said membrane filter 340 are encapsulated as a single unit. As shown in FIG. 1, in several embodiments, the fluid can be pumped by pump 2 into hydrocyclone desander 3 or mechanical solids removal unit 4. A hydrocyclone 3 can be inserted prior to the mechanical solids removal phase.

In several embodiments, the present invention is a system for FPSO with a fluid at ambient temperature comprising: a multicompartment separation tank 310 with a vent boom 312; a chemical clarifier 317; a first pump 320 with first fluid lines; solids filter skid 335 with first fluid bleed lines 336 in fluid communication with said multicompartment separation tank 310 in order to allow for bleed from said solids filter skid 335 to be transported back to said multicompartment separator tank 310; second fluid lines; membrane filtration unit 340 with second fluid bleed lines 346 in fluid communication with said multicompartment separation tank 310 in order to allow for bleed from said membrane filtration unit 340 to be transported back to said multicompartment separator tank 310; an egress line 360; wherein a fluid at ambient temperature can enter said multicompartment separation tank 310 and be treated with said chemical clarifier 317; said fluid is then then pumped by said first pump 320 through said first fluid lines into said solids filter skid 335; said fluid is then pumped into said membrane filtration unit 340 through said second fluid lines; and then fluid is pumped into said egress line 360. In several embodiments, two concentrated recirculation lines 341 and 343 run from said membrane filtration units 340 and 345 back to said first fluid line 321. In several embodiments, a carbon filter 350 is utilized after the fluid passes through said membrane filtration unit 340 and before it enters the egress line 360. In several embodiments, said membrane filtration unit 340 further comprises; a permeate tube 510 with perforation 515 and a wrapped body 505; said wrapped body 505 further comprises; multiple layers of materials including layers of a permeate spacer 525, a membrane 530, a feed channel spacer 535, and an outer wrap 540. In several embodiments, said outer wrap is nonpermeable. In several embodiments, said multicompartment separation tank 310, said pump 320, said solids filter 335, and said membrane filter 340 are encapsulated as a single unit. As shown in FIG. 1, in several embodiments, the fluid can be pumped by pump 2 into hydrocyclone desander 3 or mechanical solids removal unit 4. A hydrocyclone 3 can be inserted prior to the mechanical solids removal phase.

In several embodiments the present invention is a method for deriving oil wet solids through coalescing and removal of hydrocarbons in deck drainage, produced water, EOR Polymer Flood and ASP, or slop water comprising: providing a system comprising; a compressible oil coalescing and removal unit 113a or 113b for receiving water with solids; wherein said compressible oil coalescing and removal unit 113a or 113b comprises a compressed media for the formation of micron size of oil droplets for coalescing of emulsions and said compressed media is decompressed and agitated during a cleaning process to remove contaminate solids; wherein processing said water with solids through said compressible oil coalescing and removal unit 113a or 113b; deriving said oil wet solids from said water with solids; and removing said oil wet solids.

In several embodiments, the method further comprises; fiber said compressible oil coalescing and removal unit 113a or 113b further comprises polymeric fiber balls which attract oil and promote coalescing.-In several embodiments, the present invention is a method for coalescing and removal of hydrocarbons in slop water, deck drainage, produced water, or EOR Polymer Flood and ASP comprising: providing a system comprising; a compressible oil coalescing and removal unit 113a or 113b; wherein said compressible oil coalescing and removal unit 113a or 113b comprises a compressed media for the formation of micron size of oil droplets for coalescing of emulsions and said compressed media is decompressed and agitated during a cleaning process to remove contaminate solids; and a vertical or horizontal polishing media unit 36; wherein passing water with solids through said compressible oil coalescing and removal unit 113a or 113b into either said vertical or said horizontal polishing unit 36; and wherein water is derived from said vertical or horizontal polishing media unit 36 and is discharged, and oil derived from said process is returned to user for further use. In several embodiments, said polishing media unit is a horizontal polisher. In several embodiments, said polishing unit is a vertical polisher. Several embodiments of the present inventio utilize a pump and a tank or vessel. Several embodiments of the present invention utilize a three-phase separation vessel for release of light hydrocarbons, heavy hydrocarbon oils, and water solids.

While preferred embodiments have been shown and described, modifications thereof can be made by one skilled in the art without departing from the scope or teaching herein. The embodiments described herein are exemplary only and are not limiting. Many variations and modifications of the system and apparatus are possible and will become apparent to those skilled in the art once the above disclosure is fully appreciated. For example, the relative dimensions of various parts, the materials from which the various parts are made, and other parameters can be varied.

What is claimed is the following:

1. A method for deriving oil wet solids through coalescing and removal of hydrocarbons in deck drainage, produced water, EOR Polymer Flood and ASP, or slop water comprising:
providing a system comprising;
a compressible oil coalescing and removal unit for receiving water with solids; wherein said compressible oil coalescing and removal unit comprises a compressed media for the formation of micron size of oil droplets for coalescing of emulsions and said compressed media is decompressed and agitated during a cleaning process to remove contaminate solids; wherein
processing said water with solids through said compressible oil coalescing and removal unit;
deriving said oil wet solids from said water with solids; and
removing said oil wet solids.

2. The method of claim 1 further comprising;
said compressible oil coalescing and removal unit further comprises polymeric fiber balls which attract oil and promote coalescing.

3. A method for coalescing and removal of hydrocarbons in slop water, deck drainage, produced water, or EOR Polymer Flood and ASP comprising:
providing a system comprising;
a compressible oil coalescing and removal unit; wherein
said compressible oil coalescing and removal unit comprises a compressed media for the formation of micron size of oil droplets for coalescing of emulsions and said compressed media is decompressed and agitated during a cleaning process to remove contaminate solids; and
a vertical or horizontal polishing media unit; wherein
passing water with solids through said compressible oil coalescing and removal unit into either said vertical or said horizontal polishing unit; and wherein water is derived from said vertical or horizontal polishing media unit and is discharged, and oil derived from said process is returned to user for further use.

4. The method of claim 3 further comprising;
said polishing media unit is a horizontal polisher.

5. The method of claim 3 further comprising;
said polishing media unit is a vertical polisher.

6. The method of claim 3 further comprising;
said compressible oil coalescing and removal unit further comprises polymeric fiber balls which attract oil and promote coalescing.

7. The method of claim 4 further comprising;
passing said water with solids in said compressible oil coalescing and removal unit for oil coalescing and removal into said horizontal polishing unit.

8. The method of claim 4 further comprising;
passing water with solids in said compressible oil coalescing and removal unit for oil coalescing and removal into said horizontal polishing unit; wherein
said oil reclaimed is recycled for use.

9. The method of claim 5 further comprising;
passing water with solids in said compressible oil coalescing and removal unit for oil coalewscing and removal into said vertical polishing unit.

10. The method of claim 5 further comprising;
passing water with solids in said compressible oil coalescing and removal unit for oil coalescing and removal into said vertical polishing unit; wherein
said oil reclaimed is recycled for use.

11. A method for coalescing and removal of hydrocarbons from slop water, deck drainage, produced water, or EOR Polymer Flood and ASP comprising:
providing a compressible oil coalescing and removal unit;
said compressible oil coalescing and removal unit comprises a compressed media for the formation of micron size of oil droplets for coalescing of emulsions and said compressed media is decompressed and agitated during a cleaning process to remove contaminate solids;
said compressible oil coalescing and removal unit further comprises polymeric fiber balls which attract oil and promote coalescing; and
providing a polishing media unit; wherein
passing fluid in compressible oil coalescing and removal unit for oil coalescing and removal into said polishing media unit; and wherein
passing water in compressible oil coalescing and removal unit for oil coalescing and removal into said polishing media unit and is then discharged, and oil derived from said process is returned to user for further use.

12. The method of claim 11 further comprising;
providing a tank or vessel; and
providing a pump;
wherein fluid passed into said tank or vessel is pumped via said pump into said compressible oil coalescing and removal unit for oil coalescing and removal; said fluid is then passed into either said polishing unit; and wherein
water derived from said fluid from said tank or vessel that is pumped via said compressible oil coalescing and removal unit for oil coalescing and removal; said fluid is then passed from said vertical or horizontal polishing media unit and is discharged, and oil derived from said process is returned to user for further use.

13. The method of claim 3 further comprising;
providing a three-phase separation vessel for release of light hydrocarbons, heavy hydrocarbon oils, and water solids; and
providing a pump; wherein
said oil coalescing and removal unit comprises said compressed media for the formation of micron size of oil droplets for coalescing of emulsions and said compressed media is decompressed and agitated during a cleaning process to remove contaminate solids; wherein
water with solids passed into said three-phase separation vessel is pumped via said pump into said compressible oil coalescing and removal unit for oil coalescing and removal; and wherein
oil wet solids are derived from said water with solids that is pumped via said compressible oil coalescing and removal unit for oil wet solids removal.

14. The method of claim 11 further comprising;
providing a tank or vessel; and
providing a pump; wherein
fluid passed into said three-phase separation vessel is pumped via said pump into said compressible oil coalescing and removal unit for oil coalescing and removal; said fluid is then passed into said polishing media unit; and wherein
water derived from said fluid from said three-phase separation vessel is pumped via said compressible oil coalescing and removal unit for oil coalescing and removal; said fluid is then passed into said polishing media unit and is then discharged, and oil derived from said process is returned to user for further use.

15. The method of claim 11 further comprising;
providing a three-phase separation vessel; and
providing a pump; wherein
fluid passed into said three-phase separation vessel is pumped via said pump into said compressible oil coalescing and removal unit for oil coalescing and removal; said fluid is then passed into said polishing media unit; and wherein
water derived from said fluid from said three-phase separation vessel is pumped via said compressible oil coalescing and removal unit for oil coalescing and removal; said fluid is then passed into said polishing media unit and is then discharged, and oil derived from said process is returned to user for further use.

16. The method of claim 3 further comprising;
said compressible oil coalescing and removal unit further comprises different compressions to allow for pinpoint micron size of oil droplets.

17. The method of claim 11 further comprising;
said compressible oil coalescing and removal unit further comprises different compressions to allow for pinpoint micron size of oil droplets.

18. The method of claim 1 further comprising;
said compressible oil coalescing and removal unit further comprises different compressions to allow for pinpoint micron size of oil droplets.

19. The method of claim 11 further comprising;
said polishing media unit is a horizontal polisher.

20. The method of claim 11 further comprising;
said polishing media unit is a vertical polisher.
